(19) United States
(12) Patent Application Publication
(10) Pub. No.: US 2004/0250508 A1
(43) Pub. Date: Dec. 16, 2004

(54) Wood products with hidden joined markings and a finished veneer look

(75) Inventor: Calvin Lam, Victorville, CA (US)

Correspondence Address: Kenneth L. Sherman, Esq., Myers Dawes Andras & Sherman, LLP, Eleventh Floor, 19900 MacArthur Blvd., Irvine, CA, 92612, US

(73) Assignee: C&M WOOD INDUSTRIES, INC., Hesperia, CA

(21) Appl. No.: 10/780,062

(22) Filed: Feb. 17, 2004

Related U.S. Application Data
(60) Provisional application No. 60/448,610, filed on Feb. 19, 2003.

(51) Int. Cl. E06B 3/70; E04B 2/00

(52) U.S. Cl. 52/782.1; 52/506.01

(57) ABSTRACT

A wood slat having hidden joining marks and therefore having a desired veneer look, and method thereof is disclosed. In one embodiment, the wood slats have a long thin rectangular shape defining a face of the wood slat. The face comprises a plurality of periphery edges of first, manufactured slats; the first, manufactured slats also have a long thin rectangular shape defining a face. According to the preferred embodiment of the present invention, the plurality of periphery edges effectively hide the joining marks and give the wood slat the desired veneer look.

### PRIORITY CLAIM

This patent application claims the benefit of the priority date of U.S. Provisional Patent Application Ser. No. 60/448,610, filed on Feb. 19, 2003 and entitled Wood Products with Hidden Joined Markings And A Finished Veneer Look (Attorney Docket No. C&M1.0019-PRO) pursuant to 35 USC §119, the entire contents of this provisional patent application are hereby expressly incorporated by reference.

### BACKGROUND OF THE INVENTION

1. Field of the Invention

The present invention pertains generally to the manufacture of wood products. More particularly, the present invention pertains to processes that hide distinctly noticeable joined marks on wood products. The preferred embodiment of the present invention is particularly, but not exclusively, useful as a product or a process that provides a veneer look finish to wood blocks or slats made from joined, pre-cut wood blocks.

2. Description of the Prior Art

Processes for improving the appearance of wood and hiding or removing flaws in wood-based products are well known. Knotholes may be treated and filled with putty, for example.

Another method for improving the appearance of wood involves cutting out knots and deformities and rejoining the cutout portions without the flaws. The rejoining of the portions, typically using glue or other adhesive, will however create joining marks that also have an unpleasant appearance. In contrast, it is desired that the processing of wood yield a veneer look that provides a valuable or pleasing look.

By way of illustration, prior art FIG. 1 shows perfect wood block 2 without flaws, and having markings 4, to be cut into desired shapes or end products such as slats or other smaller pieces 6 as illustrated in FIG. 2. The dimensions of slats 6 may vary depending on their intended use, including for example, use in window frames, cornices, furniture, etc. Perfect wood blocks 2, however, are rare in nature due to a variety of natural causes related to tree growth. Additionally, if one can find flawless wood, it is very expensive for most practical applications.

FIGS. 3 through 7 illustrate a prior art method for removing existing flaws from manufactured wood products. Generally, most wood blocks 16 appear in the form illustrated in FIG. 3 with a variety of imperfections 12. These blemishes 12 may include naturally occurring defects such as knotholes, grooves, or other noticeable deformities. The slats or other smaller pieces cut from wood block 16 will obviously inherit these flaws, making them useless for many applications where appearance is important. The slab 16 must therefore be treated before it is used. As is well known in the art, one method of treatment is to cutout the blemished sections 13 of block 16, and then use its remaining flawless parts 8. Obviously, this will likely result in perfect sections 8 that are too short for many intended application, even if rejoined.

In order to address this problem of the production of manufactured wood products that are too short, two or more wood blocks are typically used to produce the same length slats (or other products) as those that came from a single wood block with no blemishes, as illustrated in FIGS. 4 to 7. After the flawed sections 13 are cutout of slabs 18, 20 along line 14, the remaining perfect sections 8 may be rejoined by a variety of well-known methods, including finger joining.

Finger joining is a process whereby the ends of each section 8 being joined are carved into complimentary zigzag shapes 24 and rejoined, as illustrated in FIGS. 5 and 6. The actual coupling of finger joins 24 may be accomplished by a variety of methods, including the use of adhesives or other well-known methods. The resulting block 30 illustrated in FIG. 6 will have no imperfections 12, except for markings 32 caused by the rejoining processes. This new block 30 is then marked 4 and cut into desired shapes such as manufactured slats or other smaller pieces 34 illustrated in FIG. 7. The markings 32 on manufactured slats 34 are not aesthetically pleasant, especially if the manufactured slats 34 are used in high-end decorative pieces such as valances, furniture, frames, or the like.

In light of the above, it is an object of the present invention to provide a wood slat, or other decorative piece of wood, with hidden joining marks, and therefore having a desired veneer look.

It is further an object of the present invention to provide a method as to hide joining marks in the processing of wood, and thereby giving the finished wood portion a superficially valuable or pleasing look.

Yet another object of the present invention is to provide a product and method for hiding joining marks in the processing of wood that is relatively simple to use and comparatively cost effective.

### BRIEF SUMMARY OF THE INVENTION

The present invention specifically addresses and alleviates the abovementioned objects by providing a finished, manufactured wood product with an unblemished veneer look. More particularly, the preferred embodiment of the present invention comprises a finished wood slat comprising multiple first, manufactured wood slats, the multiple first manufactured wood slats being laminated together and sliced along a direction perpendicular to a face plane of the first manufactured wood slats. In this preferred embodiment of the present invention, blemishes are removed and a desired veneer look is obtained.

In a further preferred embodiment of the present invention, a finished wood slat comprises a long thin rectangular shape defining a face of the wood slat. The finished wood slat is created from the combination of first, manufactured wood slats that are laminated together one atop the other to create a wood block. The wood block is then sliced in a direction that is perpendicular to the parallel faces of the first, manufactured wood slats. The face of the finished wood slat then includes a wood grain across its face, which is in reality a plurality of the periphery edges of the first, manufactured slats. The plurality of periphery edges effectively hides the joined markings and gives the wood slat a desired veneer look.

The finished wood slats are further characterized in that the joining marks that result from processing are removed from the face of the finished wood slats. Also according to the preferred embodiment of the present invention, the plurality of first, manufactured slats are laminated, and/or bonded using an adhesive. Additionally, the first, manufactured slats are selectively cut to preferred dimensions. Similarly, the finished wood slat is also selectively cut to preferred dimensions.

In another aspect, the preferred embodiment of the present invention implements a method for manufacturing a finished wood slat. In this method, joining marks resulting from processing are hidden from the finished work piece. The method comprises the steps of: providing a bulk section of wood having joining marks; cutting successive sections, the sections defining first parallel planes and forming a plurality of wood pieces in a desired shape; rejoining each of said plurality of wood pieces in a different order whereas to hide the joining marks to form a new bulk section; and cutting a second set of successive sections defining second parallel planes, the second parallel planes perpendicular to the first parallel planes, the second set of successive sections forming a plurality of wood slats having a desired veneer look.

The method additionally comprises marking the bulk section with successive lengthwise markings, the markings used for the cutting successive sections. In a preferred embodiment, the bulk section is in the form of a rectangular block; and the plurality of wood pieces are first, manufactured slats that have a thin rectangular shape. Additionally, each of the plurality of wood slats has a thin rectangular shape.

In yet another aspect, a preferred embodiment of the present invention is a wood slat, the wood slat being prepared by a process comprising the steps of: providing a bulk section of wood having joining marks; cutting successive sections, the sections defining first parallel planes and forming a plurality of wood pieces in the desired shape; rejoining each of said plurality of wood pieces in a different order to form a new bulk section; and cutting a second set of successive sections defining second parallel planes, the second parallel planes perpendicular to said first parallel planes, the second set of successive sections forming a plurality of wood slats having a desired veneer look.

The preferred process for making the wood slat additionally comprises marking the bulk section with successive lengthwise markings, the markings used for the cutting successive sections. In a preferred embodiment, the bulk section is in the form of a rectangular block; and the plurality of wood pieces are first, manufactured slats that have a thin rectangular shape. Additionally, each of the plurality of wood slats has a thin rectangular shape.

These, as well as other advantages of the present invention and the preferred embodiments will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of present invention, as well as the present invention itself and the preferred embodiment of the present invention, both as to its structure and its operation, will be best understood from the accompanying drawings, taken in conjunction with the accompanying description, in which similar reference characters refer to similar parts, and in which:

FIG. 1 is an isometric view of a perfect, prior art wood block without flaws;

FIG. 2 is an isometric view of a prior art wood slat made from the wood block of FIG. 1;

FIG. 3 is an isometric view of a prior art wood block having imperfections;

FIG. 4 is an illustration showing smaller prior art wood blocks having imperfections used to make larger wood blocks;

FIG. 5 is an isometric view of a prior art wood block having finger joins;

FIG. 6 is an isometric view of a prior art rejoined wood block;

FIG. 7 is an isometric view of prior art wood slats made from a rejoined wood block;

FIG. 8 is an isometric view of wood slats according to the preferred embodiment of the present invention;

FIG. 9 is an isometric view of rejoined slats to be sectioned along parallel planes A-A according to the preferred method of implementing the present invention; and

FIG. 10 is an isometric view of wood slats according to the preferred embodiment of present invention.

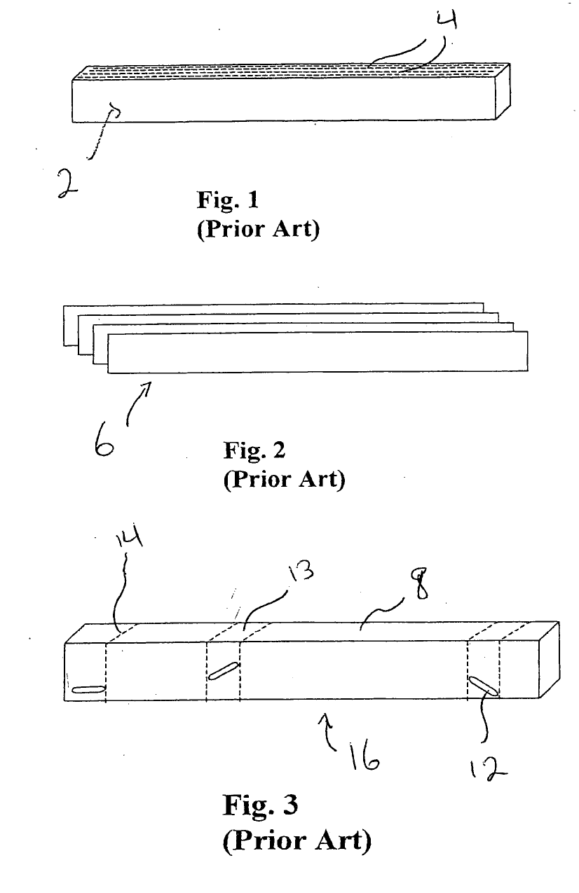

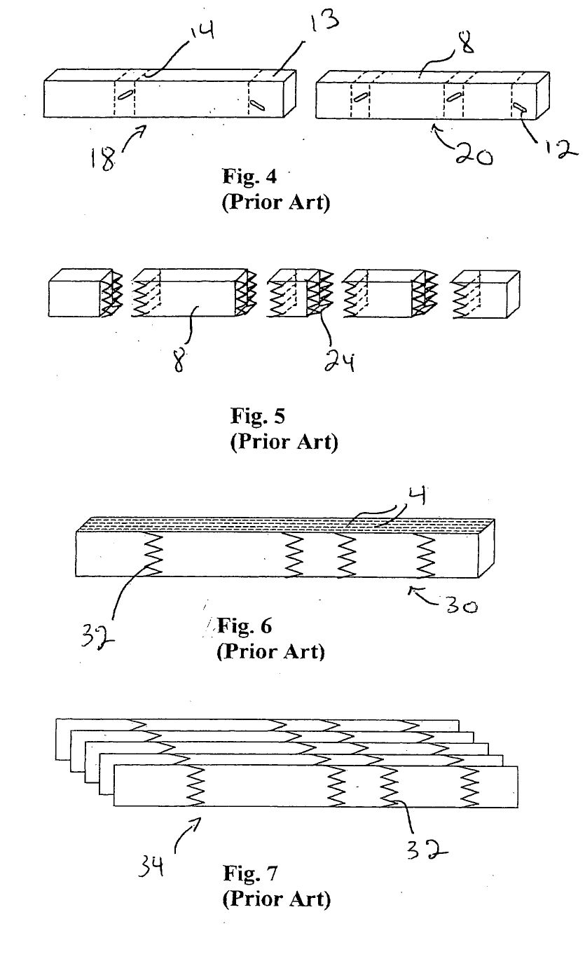

### DETAILED DESCRIPTION OF THE PREFERRED EMBODIMENTS

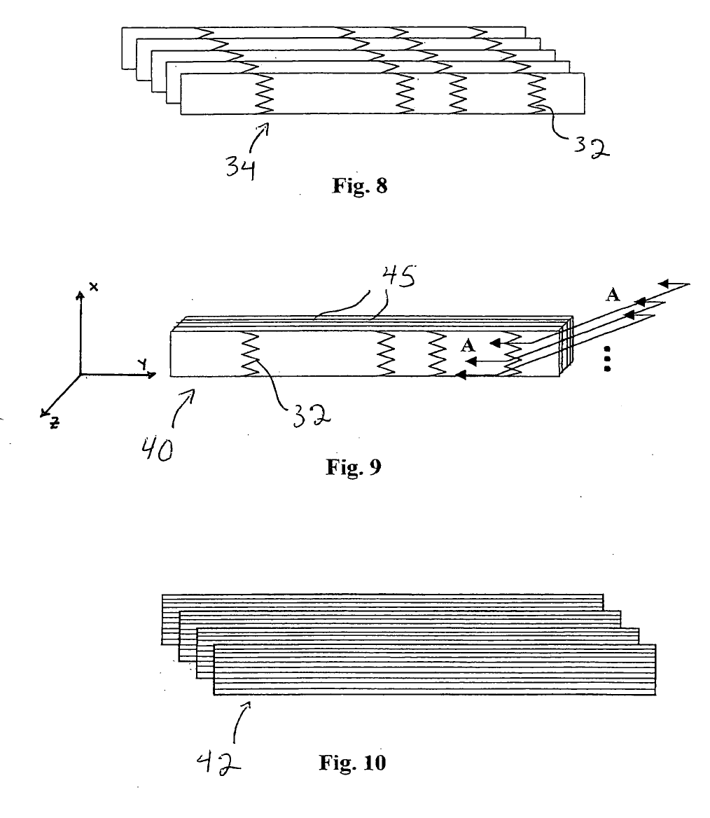

Now referring to FIGS. 8-10, new additional processing steps in accordance with the preferred embodiment of the present invention are provided to the blemished slats that result from the prior art method of producing manufactured wood products. These additional processing steps are used to hide the unpleasant joining marks 32 which result from the prior art.

In the preferred embodiment, FIG. 8 illustrates first manufactured slats 34 having joining marks 32 which were cut from rejoined block 30. The first manufactured slats 34 are then laminated to form a new bulk section in the form of block 40 as illustrated in FIG. 9.

This new block 40, shown in FIG. 9, shows joining marks 32 (running in a zigzag pattern along a plane parallel to the X-Y plane illustrated in FIG. 9), and shows the periphery edges 45 of each first manufactured slat 34 (running in a line parallel to the Y axis so that the combination of the slat periphery edges 45 have parallel lines which sit in a plane parallel to the Y-Z plane illustrated in FIG. 9).

The coupling of the first manufactured slats 34 may be accomplished by a variety of different methods, which may or may not include the use of glue or adhesives. The coupling merely ensures that the first manufactured slats 34 are laminated or combined together to form a singular block 40. One benefit of this process is that the newly formed block has a simulated wood grain veneer where the wood grain runs parallel to the Y-axis.

The next processing step in accordance with a preferred method for implementing the preferred embodiment of the present invention is to cut the new block 40. In the preferred embodiment of the present invention, the finished products are non-blemished, finished manufactured wood slats 42. However, the present invention may be used to manufacture any finished, manufactured wood product in conformity with the principals defined herein.

In the preferred method to implement the preferred embodiment of the present invention, the finished, manufactured wood block 40 is cut to preferred dimensions along the direction illustrated in FIG. 9 by the reference letters A-A. As is shown in FIG. 9, this direction A-A is a cut of the wood block along a plane parallel to the Y-Z axis. By implementing this preferred method of implementing the present invention, the resulting new finished manufactured slats 42 from block 40 will not show any joined markings 32 and will have the desired veneer look.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Wood Product with Hidden Joined Markings And A Finished Veneer Look as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A finished wood slat comprising: multiple first, manufactured wood slats, the multiple first manufactured wood slats being laminated together and sliced along a direction perpendicular to a face plane of the first manufactured wood slats.

2. A finished wood slat comprising:
a long thin rectangular shape defining a final face of the finished wood slat, said face having a wood grain, the wood grain resulting from periphery edges of a plurality of first, manufactured slats, said first, manufactured slats being combined together.

3. The wood slat of claim 2, wherein the plurality of first, manufactured wood slats have joining marks that result from processing, and wherein the joining marks in the finished wood slat are hidden.

4. The wood slat of claim 2, wherein said plurality of first, manufactured slats are laminated.

5. The wood slat of claim 2, wherein said plurality of first, manufactured slats are bonded using an adhesive.

6. The wood slat of claim 2, wherein said plurality of first, manufactured slats are selectively cut to preferred dimensions, and wherein the finished wood slat is selectively cut to preferred dimensions.

7. A method for making a wood slat, the method comprising:
providing a bulk section of wood;
cutting successive sections, the sections defining first parallel planes and forming a plurality of wood pieces in a desired shape;
rejoining each of said plurality of wood pieces in a different order to form a new bulk section; and
cutting a second set of successive sections defining second parallel planes, the second planes perpendicular to said first parallel planes, the second set of successive sections forming a plurality of wood slats.

8. The method of making a wood slat of claim 7, wherein the bulk section of wood has joining marks, and wherein the method effectively hides the joining marks.

9. The method of making a wood slat having hidden joining marks of claim 8, further comprising marking said bulk section with successive lengthwise markings, the markings used for said cutting successive sections.

10. The method of making a wood slat having hidden joining marks of claim 8, wherein said bulk section is in the form of a rectangular block.

11. The method of making a wood slat having hidden joining marks of claim 8, wherein each of said plurality of wood pieces are first, manufactured slats that have a thin rectangular shape.

12. The method of making a wood slat having hidden joining marks of claim 8, wherein each of said plurality of wood slats have a thin rectangular shape.

13. A wood slat prepared by a process comprising:
providing a bulk section of wood;
cutting successive sections of the bulk section of wood, the sections defining first parallel planes and forming a plurality of wood pieces in the desired shape;
rejoining each of said plurality of wood pieces in a different order to form a new bulk section; and
cutting a second set of successive sections defining second parallel planes, the second parallel planes perpendicular to said first parallel planes, the second set of successive sections forming a plurality of wood slats having the desired veneer look.

14. The wood slat prepared by the process of claim 13, further comprising marking said bulk section with successive lengthwise markings, the markings used for said cutting successive sections.

15. The wood slat prepared by the process of claim 13, wherein said bulk section is in the form of a rectangular block.

16. The wood slat prepared by the process of claim 13, wherein each of said plurality of wood pieces are first, manufactured slats that have a thin rectangular shape.

17. The wood slat prepared by the process of claim 13, wherein each of said plurality of wood slats have a thin rectangular shape.
